(19) United States
(12) Patent Application Publication
(10) Pub. No.: US 2005/0234911 A1
(43) Pub. Date: Oct. 20, 2005

(54) Methods and systems for user requested mail delivery services

(76) Inventors: Juliaann Sanders Hess, Weston, FL (US); Charles K. Sullivan, Raleigh, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/934,457

(22) Filed: Sep. 7, 2004

Related U.S. Application Data
(60) Provisional application No. 60/500,242, filed on Sep. 5, 2003.

(51) Int. Cl. G06F 17/30

(52) U.S. Cl. 707/9

(57) ABSTRACT

Methods and systems are provided for handling customer requests regarding delivery services. These methods and systems include receiving via a network, such as the Internet, a customer request regarding delivery services, validating the received information and sending the information to a database for recordation. Then, in response, receiving an indication from the database regarding whether the information was successfully recorded and sending to the customer a confirmation number regarding the recorded information. For example, a user desiring hold mail or redelivery services may navigate to a web page of the delivery service for requesting these services. The user may then enter information regarding their request for services. This request may then be forwarded to a database that is accessible by the particular delivery unit that provides delivery services to the user's address. The delivery unit may then retrieve and handle the user's request accordingly.

This application claims priority to U.S. Provisional Application No. 60/500,242, filed on Sep. 5, 2004, the contents of which are hereby incorporated by reference into this application as if set forth herein in full.

### TECHNICAL FIELD

The invention relates to the field of delivery services, and more specifically, a system for and method of receiving and handling user requests regarding delivery services.

### BACKGROUND

Customers of mail delivery services, such as postal service customers, at times desire special delivery services regarding handling of their mail. For example, a postal service customer leaving for a vacation may desire that their mail be held by the post office until their return. Traditionally, postal service customer have had to make a request for special delivery services by coming to the post office and filling out a special form. This, however, was inconvenient and time consuming for a postal service customer. If, at a later date, a postal service customer wanted to change, modify, or cancel a request for a special delivery services, another trip to a postal office was required.

Recently, postal service customers have also been able to make special delivery services request by calling a nationwide 1-800 style number and speaking to an operator who records their request and forwards it to a nationwide database. This database may be accessible by the individual delivery units that deliver the mail. These individual delivery units may access the database to retrieve the special delivery requests and handle these requests accordingly. This, however, may incur the personnel costs associated with hiring live operators. Also, this may be inconvenient for the postal service customer if they are placed on hold or the operator has difficulty transcribing the names and addresses spoken via the telephone by the customer.

In another example, often postal service carriers attempt to deliver packages to postal customers who are not at home to receive the package. Traditionally, the postal service carrier leaves a note on the door indicating that they attempted to deliver the package. This notice often allows the postal customer to insert information regarding redelivery of the package and then place the notice in their mail box for the postal carrier. This is however inconvenient for the user if the user wishes to later modify their request.

Accordingly, there is a need for improved methods and systems for efficient and cost effective systems and methods for receiving and handling user requests regarding special delivery services.

### SUMMARY

Consistent with the invention, methods and systems are provided that include receiving via a network a customer request regarding delivery services, validating the received information and sending the information to a database for validation and recordation. Additionally, these methods and systems include receiving an indication from the database regarding whether the information was successfully recorded and sending to the customer a confirmation number regarding the recorded information.

After a customer request is recorded in a database, individual delivery units may retrieve information regarding delivery and print it out for further forwarding to the individual carriers handling delivery to addresses identified on the requests. The individual carrier may then ensure that the requested services are provided.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 illustrates a block diagram of an exemplary network, consistent with the invention;

FIG. 2 illustrates an exemplary flow diagram of a method for sending and receiving a user request for special delivery services, consistent with the invention;

FIG. 3 illustrates an exemplary flow diagram of a method for forwarding special service request to individual carriers, consistent with the invention;

FIGS. 4-A, 4-B, and 4-C illustrate an exemplary flow diagram of a method for receiving a user request regarding delivery services and recording the request in a database, consistent with the invention;

FIG. 5 illustrates an exemplary screen that may be displayed to a user requesting special delivery services, consistent with the invention;

FIG. 6 illustrates an exemplary screen that may be displayed to a user checking availability of special delivery services, consistent with the invention;

FIG. 7 illustrates an exemplary screen that may be provided to a user allowing them to enter a name, address, and phone number, consistent with the invention;

FIG. 8 illustrates an exemplary screen that may be displayed to a user for verification of an address, consistent with the invention;

FIG. 9 illustrates an exemplary screen that may be displayed to a user for entering information associated with a request to hold mail services, consistent with the invention;

FIG. 10 illustrates an exemplary screen that may be displayed for a user for verification of the received information associated with a request to hold mail services, consistent with the invention;

FIG. 11 illustrates an exemplary screen that may be displayed for a user for providing the user with a confirmation number of a special delivery services request, consistent with the invention;

FIG. 12 illustrates an exemplary screen that may be displayed to a user for entering information associated with a redelivery request, consistent with the invention;

FIG. 13 illustrates an exemplary screen that may be displayed to a user for retrieving additional information regarding a redelivery request, consistent with the invention; and

FIG. 14 illustrates an exemplary screen that may be displayed to a user for verification of a redelivery request, consistent with the invention.

### DESCRIPTION

Reference will now be made in detail to the exemplary embodiments of the invention, examples of which are illustrated in the accompanying drawings. Wherever possible, the same reference numbers will be used throughout the drawings to refer to the same or like parts.

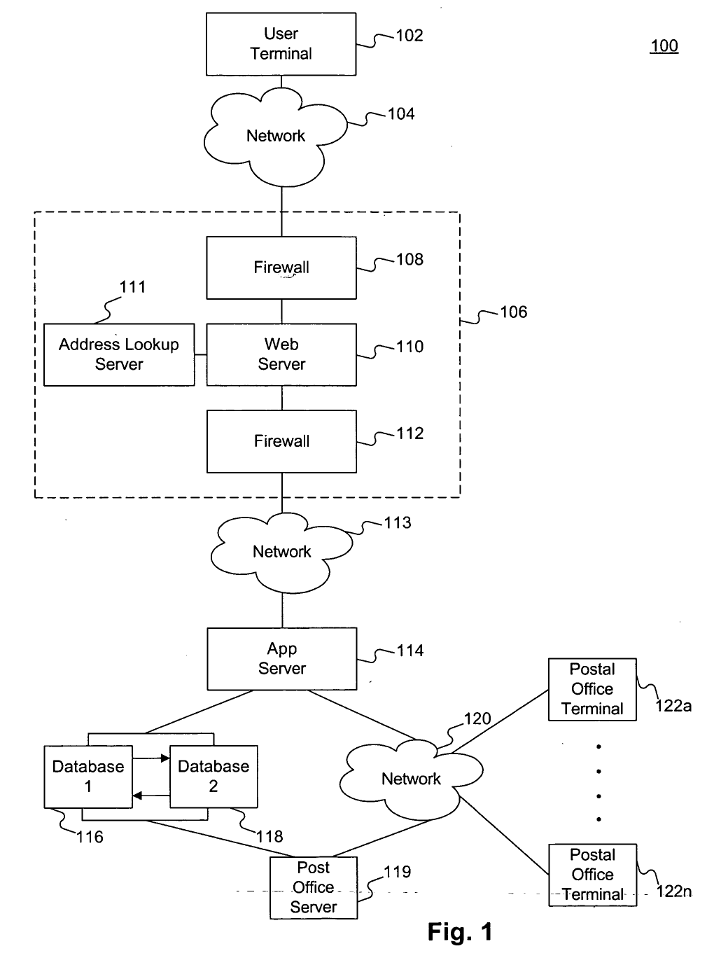

FIG. 1 illustrates an exemplary block diagram of a system 100, consistent with the invention. As illustrated, a user terminal 102 connects to a network 104. Network 104 may be any appropriate type of network, such as, for example, an internal network (intranet) or a public network (e.g. the internet). Additionally, network 104 may utilize any suitable type of network protocol. For ease of explanation, network 104 will be hereinafter referred to as Internet 104 and will be assumed to use TCP/IP. However, it should be understood that the network 104 may be any appropriate type of network using any appropriate type of suitable protocol.

User terminal 102 may be any appropriate type of user terminal, such as, for example, a user computer executing a web browser-type program, such as Microsoft Internet Explorer or a Netscape Navigator. Accordingly, user terminal 102 may include a processor, memory, storage, and an interface for connecting to Internet 104.

Additionally, a service center 106 connects to network 104. As illustrated, service center 106 includes a web server 110 connected to network 104 via a firewall 108. Web server 110 is additionally connected via a network 113 to an application server 114 through a firewall 112. Web server 110 may be any appropriate type of computer and may include, for example, a processor, memory, storage, and interfaces. Firewalls 108 and 112 may any appropriate type of firewall, such as, for example, commercially available firewalls. Network 113 may be any type of network such as, for example, an internal network for the postal service.

Additionally, web server 110 is illustrated as connected to an address lookup server 111 that may be any appropriate type of computer and may include, for example, a processor, memory, storage, and interfaces.

Application server 114 may connect to databases 116 and 118. Databases 116 and 118 may be any appropriate type of database, and may use, for example, proprietary or commercially available software such as Oracle. Databases 116 and 118 may share information such that each database includes a copy of all information on the other. Accordingly, data may be written to or retrieved from either database, although, in the below description, information is described as being written to and retrieved from database 118. One of skill would understand that the information may be written to or retrieved from either database 116 or 118.

Additionally, a post office server 119 may connect to databases 116 and 118. Post office server 119 may be any appropriate type of computer and may include, for example, a processor, memory, storage, and interfaces.

Additionally, as illustrated, post office server 119 connects to a network 120, that may be for example, an internal network for an organization providing delivery services (e.g., an internal network for the postal service). For ease in explanation, network 120 will be hereinafter referred to as intranet 120. One of skill in the art will recognize, however, that intranet 120 in other embodiments may be any appropriate type of network such as, for example, the Internet. Additionally, although networks 104, 113, and 120 are illustrated separately, it should be understood that they may be the same network.

Additionally, a plurality of delivery unit terminals 122 also connect to intranet 120. These delivery unit terminals 122 may be any appropriate type of computer and may include, for example, a processor, memory, storage, and interfaces. These delivery unit terminals 122 may be located in the offices of the individual delivery units (e.g., local post offices) providing delivery services to the addresses assigned to the delivery unit.

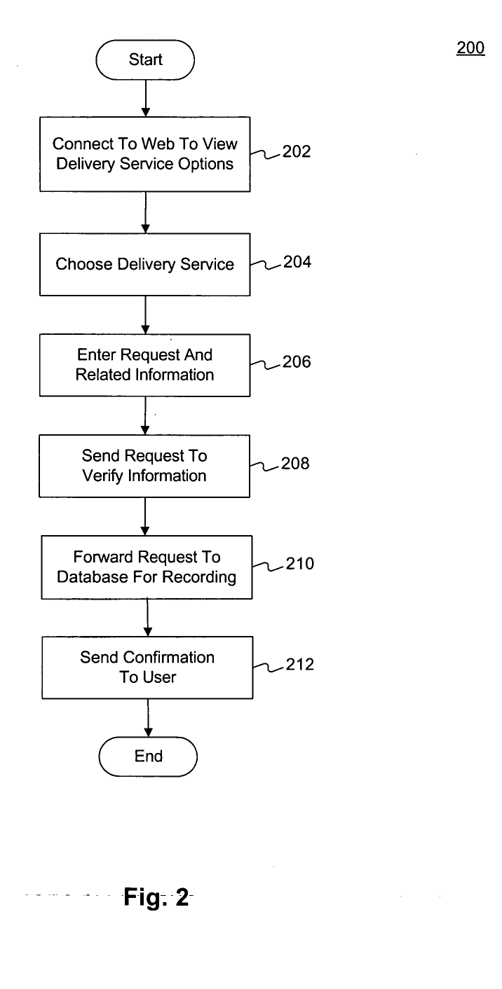

FIG. 2 illustrates an exemplary flow diagram of a method for sending and receiving a user request for special delivery services. In an exemplary embodiment, a customer using a user terminal 102 (FIG. 1) with a web browser type program may connect via the Internet 104 to the web server 104 to view a web page for the delivery service. (202). The customer may then navigate through the web pages to the desired services (e.g., hold mail or redelivery services). (204). The customer then may enter information regarding their request and save it such that the user computer 102 sends the request to the web server 110. (206). The web server 110 may then send this information to application server 114, which verifies the information for correctness and completeness. (208). The application server 114 then passes the information to the database 118, which records the information. (210).

Once the information is successfully recorded, the database 118 returns a code to the application server 114 advising of the success of the information capture. The application server 114 then forwards the return information (e.g., the recorded information) along with a confirmation number to the web server 110. The web server 110 then formats the information and sends it to the user terminal 102, which displays the information to the user. (212). The user may then print out the confirmation number so that if they desire they may later modify the request.

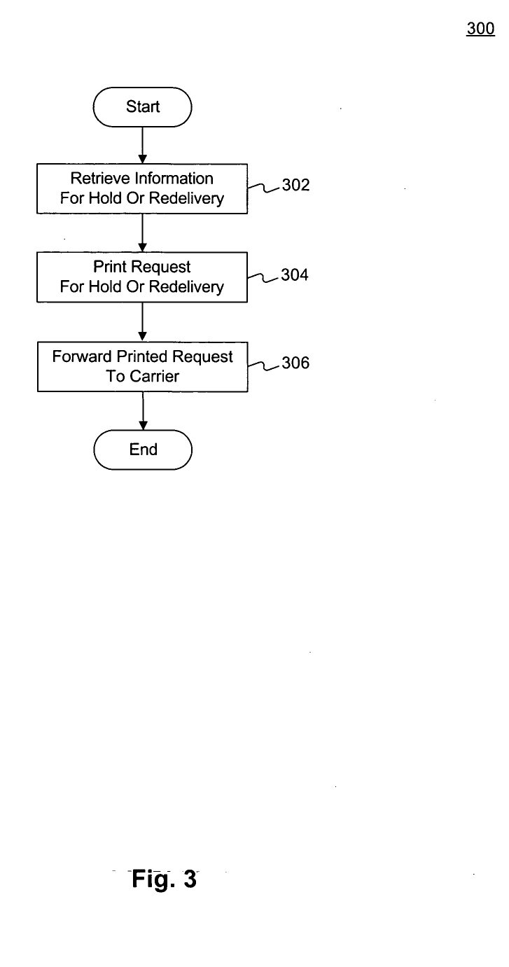

FIG. 3 illustrates an exemplary flow diagram of a method for forwarding special service requests to individual carriers. In an exemplary embodiment, individual delivery units may log on to the database 118 (FIG. 1) via their delivery unit terminal 122n to retrieve information regarding delivery to the addresses handled by that delivery unit. (302). Retrieval of the customer requests for special delivery services may be performed on the regular basis, for example, daily. The database 118 may then send information to the postal office terminal 122 regarding the requested services. For example, if the customer requested hold mail services, the database may send information regarding the request starting the day before the request through the day after the request. These requests may then be printed out using the delivery unit terminal 122. (304). Then printed service requests may be given to the individual carriers handling delivery to addresses identified on the requests. (306). The individual carrier may then ensure that the requested services are provided.

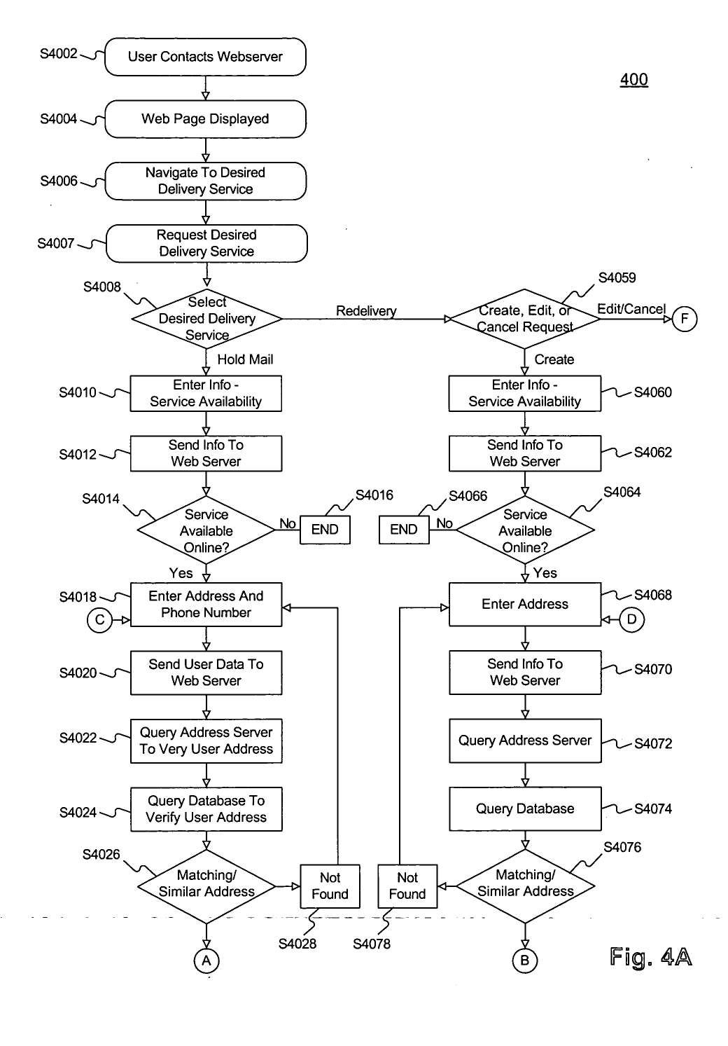

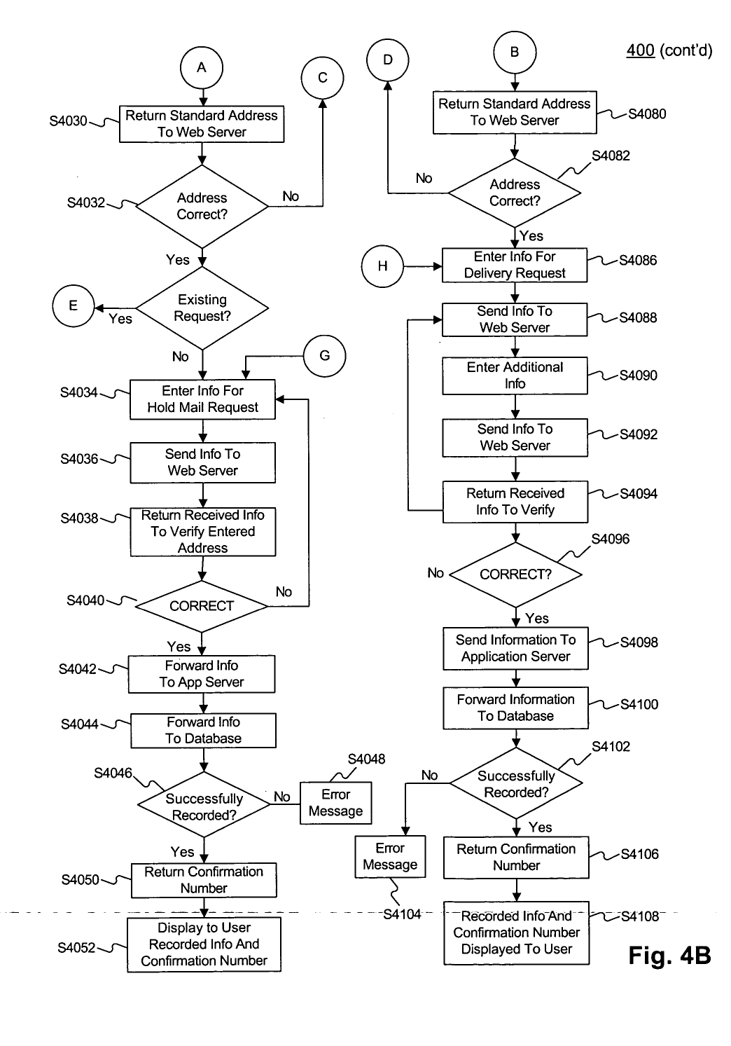

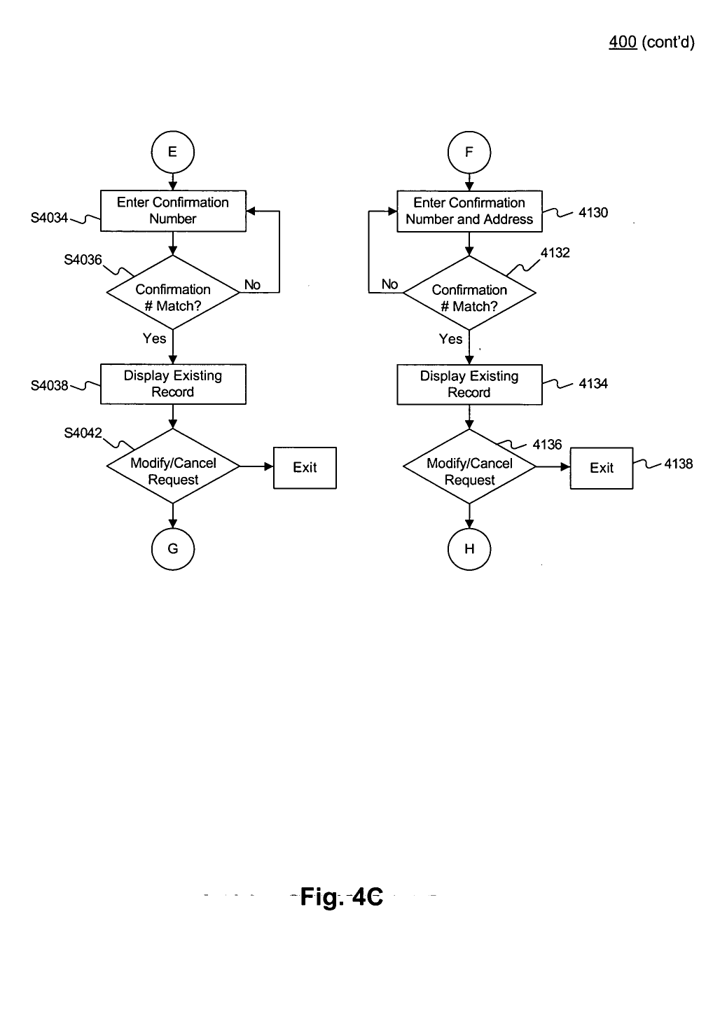

FIGS. 4A, 4B, and 4C illustrate an exemplary flow diagram of a method for receiving a user request regarding delivery services and recording the request in a database, consistent with methods and systems consistent with the invention.

A user may initiate a request for delivery services by contacting web server 110 (FIG. 1) using a web browser executing on user terminal 102. (4002). For example, a user may select to connect to the network 104 using the web browser by entering a Uniform Resource Locator (URL) identifying web server 110 (e.g., www.usps.com). In response, user terminal 102 may contact the web server 110 via network 104, where firewall 108 is programmed to permit information regarding a web page for the web server 110 to be sent to the user terminal 102. In response, a web page is displayed on user terminal 102 using the web browser. (4004). The user may then navigate through the displayed web pages to request a desired delivery service. (4006). For example, the user may navigate to a web page for selecting the desired delivery services (e.g., hold mail or redelivery services).

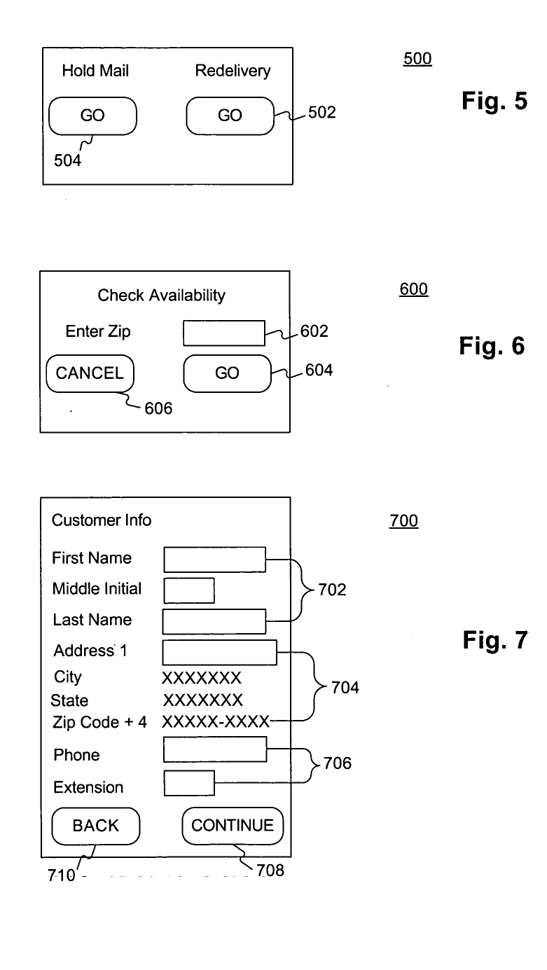

FIG. 5 illustrates an exemplary screen 500 that may be displayed to a user requesting delivery services. Screen 500 may provide selection “buttons” for the user to select the type of the desired service. For example, as illustrated, screen 500 may provide the user with a button 502 for requesting hold mail services and a button 504 for requesting redelivery services. Screen 500 may receive a user selection of the type of service the user desires, for example, by receiving a mouse click. (4008, FIG. 4A). Additionally, the user may be presented with options for modifying or canceling existing hold mail redelivery requests.

If the user selects hold mail services, the user may be presented with a screen for entering information to determine whether the requested services are available to them online. (4010). FIG. 6 illustrates an exemplary screen 600 that may be displayed to a user to check availability of services. As illustrated, screen 600 may include a box 602 for receiving a user-entered ZIP code. Additionally, screen 600 may include a button 604 (e.g., the “Go” button) for receiving a user indication that they have entered their ZIP code and/or a user inquiry as to whether services are available online. Screen 600 may also include a button 606 for receiving a cancellation request.

Once the user enters their ZIP code and selects the go button, the information is sent from user terminal 102 to web server 110. (4012). Web server 110, in response, sends information to application server 114 which may look up in a table stored by database 116 to determine whether the requested service is available online to the ZIP code entered by a user. (4014). If the requested delivery service is not available online, a screen indicating so may be displayed to the user. (4016). If so, the user may be presented with a screen for entering their address and phone number. (4018).

FIG. 7 illustrates an exemplary screen 700 that may be provided to display received user entries of name 702, address 704, and phone number 706. Because the user previously entered their ZIP code, the user's city and state may be automatically populated in the address field so that the user need not enter this information. Once the user enters this information, the system may receive a user selection of a continue button 708 to continue or of a back button 710 to return to screen 600.

After the user enters the requested information, user terminal 102 sends the information to web server 110. (4020). Web server 110 then sends a query to address lookup server 111 to verify the received information. (4022). Address lookup server 111 may then send a query to database 116 to verify the address. (4024). Although, in this example, address lookup server 111 queries database 118 to verify the address, in other examples, address lookup server 111 may query database 116, a database stored by address lookup server 111, or some other stored records to verify address information.

Address lookup server 111 then determines if there is a matching or a similar address in database 118. (4026). For example, the user may have entered the address in a non-standard format, such as for example, entering “Street” or “Str.” rather than using “ST”.

If address lookup server 111 cannot locate the address, address server 111 returns a message to web server 110 indicating that the address could not be found. Web server 110 then may forward this message to user terminal 102, which in response, may provide the user with a screen similar to screen 700 that informs the user that the entered information was incorrect and requesting the user to reenter the information. (4028). The user may further be returned to stage 4018 so that they may reenter their address.

If address lookup server 111 finds a matching or similar address, address lookup server 111 returns this address to web server 110, which in turn returns the address to user terminal 102. (4030).

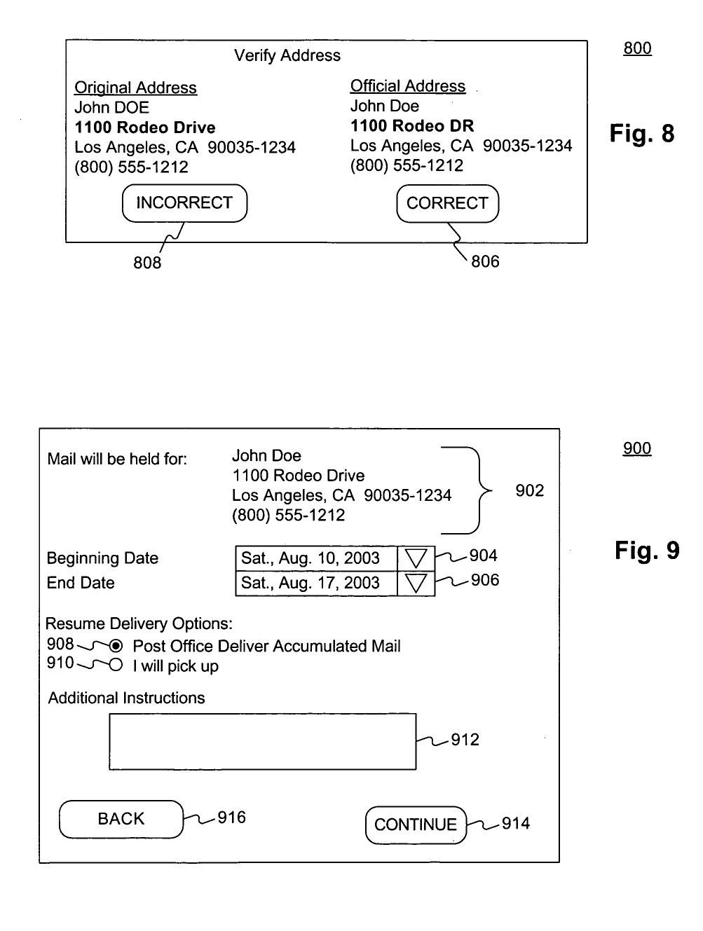

Web server 110 may then send instructions to user terminal 102 to display a screen requesting the user to verify the address. (4032). FIG. 8 illustrates an exemplary screen 800 that may be displayed to a user to verify the address, consistent with methods and systems consistent with the invention. As illustrated, screen 800 may display the address 802 entered by the user along with an official address 804 returned by address lookup server 111. This screen may also display in bold information that is different between the two addresses. Additionally, screen 600 may include a button 806 for receiving a selection that the information is correct and a button 808 for receiving a selection that the information is incorrect. If the user selects incorrect button 808, the user may be returned to screen 700 so that the user may reenter their address.

After the user indicates that their address information is correct, web server 110 may send instructions to application server 114 which queries database 118 for an active hold mail record for the address. (4033). If no active hold mail record exists in database 116 for the address, web server 110 may display a screen to user terminal 102 so that the user may enter information requesting hold mail services. (4034).

FIG. 9 illustrates an exemplary screen 900 that may be displayed for a user to enter information requesting hold mail services. As illustrated, screen 900 may identify an address 902 for which hold mail services are being requested. Additionally, screen 900 may include a scroll box 904 for receiving a selection of the day on which the user desires hold mail services to begin. In an embodiment, this scroll box 904 may list, for example, the days for the next 90 days. Additionally, screen 900 may include a scroll box 906 for receiving a selection of the date for which the user desires hold mail services to end.

Screen 900 may also include “radio buttons” for selecting how the held mail should be handled once hold mail services end. For example, screen 900 may include a radio button 908 for receiving a selection for held mail to be delivered to the customer's address after the hold mail service period has ended. Alternatively, a user selection at a check box 910 may be received to indicate that the user desires their held mail to be held at the post office until it is picked up. Screen 900 may also include a box 912 to receive additional user-entered instructions regarding their hold mail request. After the user enters the information, they may click on a continue button 914 to continue or a back button 916 to return to screen 800.

After the user enters the information regarding the hold mail request, the information is sent from user terminal 102 to web server 110. (4036). Web server 110 then sends the information to application server 114 which queries the information against business rules in database 118. These business rules may include, for example, ensuring that the hold mail period is not over 30 days, that the start date is not the current or a previous day, and that the end date is after the start date. If the request complies with the business rules in database 118, web server 110 may reformat the information and send an instruction to user terminal 102 to display the received information so that the user may verify that it is correct. (4038). A user-entered verification may be received to validate that the information is correct. (4040).

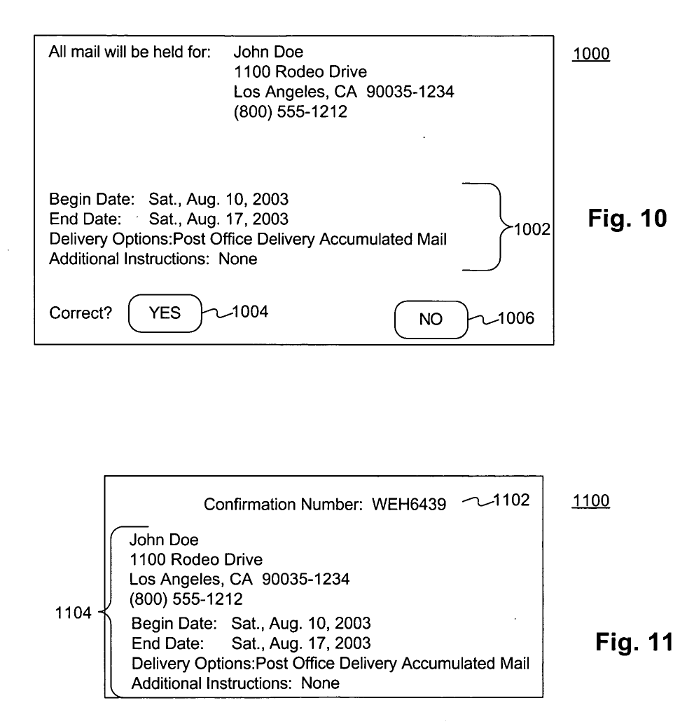

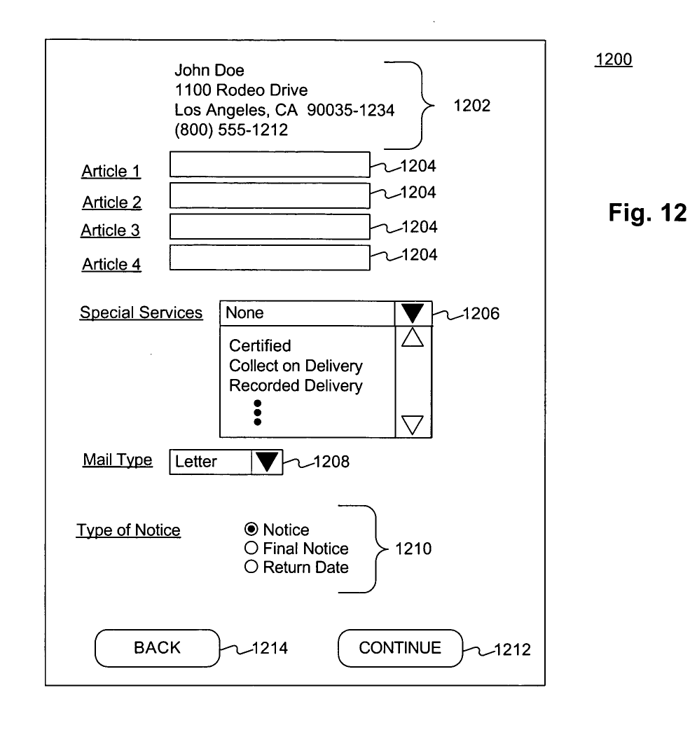

FIG. 10 illustrates an exemplary screen 1000 that may be displayed for a user to verify that the received information requesting hold mail services is correct. As illustrated, screen 1000 may display information 1002 entered by the user along with a YES 1004 button for receiving an indication that the information is correct and a NO button 1006 for receiving an indication that the information is not correct.

If notification that the information is not correct is received (button 1006 is clicked), the user may be returned to screen 900 to correct the information.

Once the user verifies the information and indicates that it is correct, web server 110 forwards the information to application server 114. (4042). Application server 114 then passes the information to database 118 so that it may be recorded. (4044). Additionally, database server 118 may assign a service center to indicate from which service center the request is from. As discussed above, a user may also request hold mail services via the telephone. In such a case, the assigned service center identifier indicates which telephone service center is making the request. In this example, the service center identifier indicates that the request is via web server 110. Database 118 then attempts to record the information and determines if the information was successfully recorded. (4046).

If the information is not successfully recorded, database 118 may send a failure code to application server 114, which in response, may try again or send a message to web server 110 to inform the user that there was a failure and that the user should try again later. (4048).

Once the information is successfully recorded, database 118 may return a confirmation number to application server 114 which may then forward the recorded information and the confirmation number to web server 110. (4050). Web server 110 may then format the information to a user friendly display that it forwards to user terminal 102 for displaying a screen informing the user of the recorded information and confirmation number. (4052).

FIG. 10 illustrates an exemplary screen 1100 that may be displayed for a user to provide the user with a confirmation number for the request. As illustrated, screen 1100 provides a confirmation number 1102 along with the user-provided instructions regarding a request 1104.

The user may then in the future use the confirmation number by entering it, for example, via an appropriate web page, to modify or cancel the request. The user may then be presented with a web page, such as screen 900 which includes the previously supplied information. The user may then proceed from stage S4034.

For example, referring back to stage 4033 (FIG. 4B), if there was an existing hold-mail request for the address, the user may be prompted to enter their confirmation number. (4120). Web server 110 may then send the confirmation number to application server 114, which queries database 118 for a match between the address and the confirmation number. (4122). If the confirmation number matches the address, the previously supplied information for the hold mail request is retrieved from database 118 and displayed to the user using a screen such as screen 900. (4126). The user may then use these screens to modify or cancel this request, or the user may elect not to modify the request and instead exit. (4128).

Referring back to stage 4008 (FIG. 4B) and exemplary screen 500 (FIG. 5), if the user selects redelivery services rather than hold mail services, the user may be presented with a screen for receiving a selection of whether they wish to create a new request or modify an existing request. (4059). If the user elects to create a new request, the user may be presented with a screen for entering information to determine whether the requested services are available to them. (4060). This screen may be, for example, identical or similar to screen 600.

Once the user enters the information, user terminal 102 sends the information to web server 110. (4062). Web server 110, in response, may look up in a table stored by web server 110 whether the requested service is available to the entered by the user ZIP code online. (4064). If not, a screen may be displayed to the user indicating that the requested services are not available online. (4066). If so, the user may be presented with a screen for entering user address and phone number. (4068). This screen may be, for example, similar to or identical to the above-described screen 700.

After the user enters the requested information user terminal 102 sends the information to web server 110. (4070). Web server 110 then sends a query to address locator server 111 to verify the received information. (4072). Address locator server 111 may then send a query to database 118 to verify the address. (4074). Address lookup server 111 then checks to see if there is a matching or a similar address. (4076). For example, the user may enter the address in a non-standard format, such as for example entering “Street” or “Str.” rather than using “ST”.

If address lookup server 111 cannot locate the address, address lookup server 111 returns a message to web server 110 indicating that the address could not be found which forwards the message to user terminal 102 so that the user may be presented with a screen similar to screen 700 that informs the user that the entered information was incorrect and requesting the user to reenter the information. (4078). The user may further be returned to stage 4068 to reenter the user address.

If address lookup server 111 finds a matching or similar address, address lookup server 111 returns this address to web server 110, which may return the address to user terminal 102. (4080).

Web server 110 may then send instructions to user terminal 102 to display a screen requesting the user to verify the address. (4082). This screen may be, for example, similar or identical to screen 600.

After the user indicates that their address information is correct, web server 110 may send instructions to user terminal 102 to display a screen so that the user may enter information requesting redelivery services. (4086).

FIG. 10 illustrates an exemplary screen 1200 that may be displayed to a user for entering information regarding a redelivery request. As illustrated, screen 1200 may display an address 1202 for which services are being requested. Additionally, screen 1000 may include boxes 1204 for receiving article numbers identifying the items to be redelivered. These article numbers may, for example, be listed on a notice left with the customer regarding the attempted delivery of the items (e.g., a United States Postal Service PS Form 3849 Delivery Notice/Reminder/Receipt form). Additionally, each user entry field may also have hyperlinks to help information to assist the user in understanding the entry field.

Additionally, screen 1200 may include a scroll box 1206 for receiving a selection of the desired special services. Special services are typically options available to the sender of the item, and may include Insurance, Certified Mail, Registered Mail, Signature Confirmation, and Delivery Confirmation. Additionally, the special services for the delivery item may be identified on the notice left with the customer regarding the attempted delivery of the items (e.g., a United States Postal Service PS Form 3849 Delivery Notice/Reminder/Receipt form). Additionally, if more than one special service is marked on the notice, the user may hold down the “CTRL” key and click on the multiple items in scroll box list 1206 to select the multiple items.

Screen 1200 may also include a scroll box 1208 for receiving a description of the physical characteristics of the mail piece attempted to be delivered These different mail types may include, for example, letter, large envelope, parcel, or perishable. Additionally, the mail type for the item may be identified on the notice left with the customer.

Screen 1200 may also include radio buttons 1210 for receiving a selection of the type of notice left with the customer, such as, for example, first notice, final notice, return date. This information may also be included on the notice left with the customer.

Once the user has entered the requested information, the system may receive a user-entered command or a continue button 1212 to continue. Or, the user may click on a back button 1214 to return to the previous screen.

After the user enters this initial information, user terminal 102 sends the entered information to web server 110. (4088). Web server 110 may then send an instruction to application server 114 to validate the information against business rules in database 118. If the information complies with the business rules, application server 114 sends information to web server 110 which formats it for display on a screen for entering additional information regarding the redelivery request. (4090).

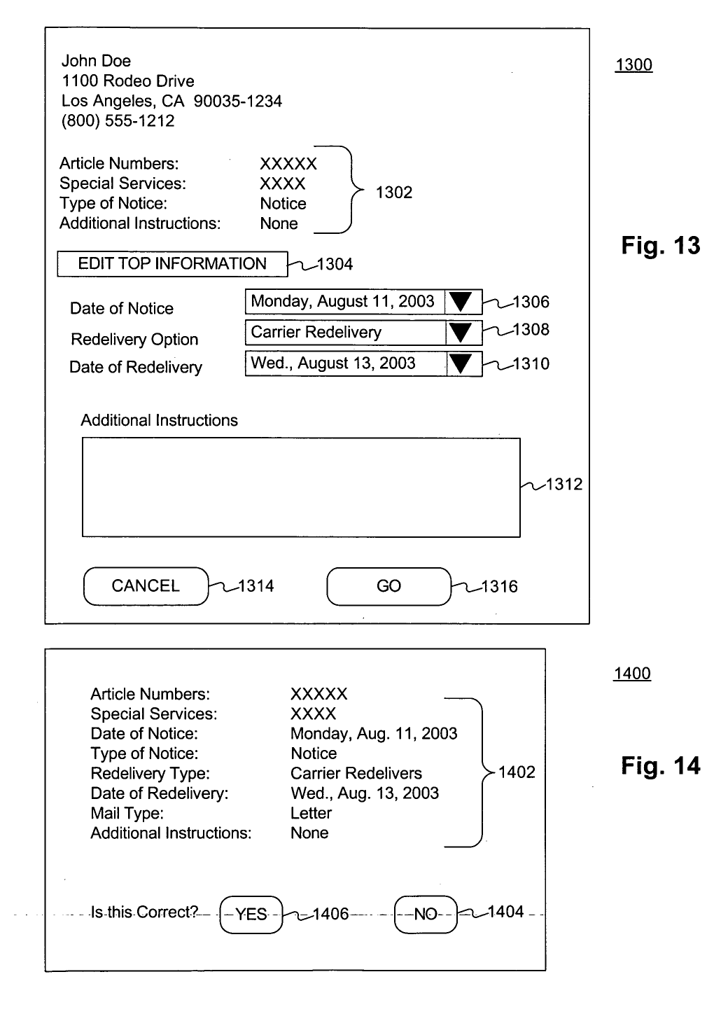

FIG. 13 illustrates an exemplary screen 1300 that may be displayed to a user to retrieve additional information regarding a redelivery request. As illustrated, screen 1300 may display the information previously provided by the user 1302, such as for example, the address, article numbers, etc. Additionally, screen 1300 may include a button 1304 for receiving a user selection to return to screen 1200 and edit the previously provided information. Screen 1300 may also include a scroll box 1306 for receiving a selection of the date of the notice. Screen 1300 may further include a scroll box 1308 for receiving a selection of the desired redelivery option. These options may include carrier redelivery, customer pickup, or return to sender. If the user selects the carrier redelivery option, a scroll box 1310 for selecting a redelivery date may be displayed on screen 1300. The user may then select a day for this scroll box when the item to be redelivered. Additionally, screen 1300 includes a box 1312 for receiving additional user instructions regarding the redelivery. Screen 1300 further includes a back button 1314 for receiving an indication that a user wants to return to screen 1200. Once the information is entered, a Continue button 1316 may be clicked to continue.

After the information regarding the redelivery request is entered, the information is sent from user terminal 102 to web server 110. (2092). Web server 110 may then send the information to application server 114 which sends the information to database 118. Database 118 validates the request against business rules. If information complies with the business rules, it returns and acknowledgement to application server 114. Application server may then send the information to web server 110. Web server 110 may send instruction to the user terminal to display the received information so that the user may verify that it is correct. (4096).

FIG. 14 illustrates an exemplary screen 1400 that may be displayed to verify the request for a special delivery. As illustrated, this screen may list the user provided information regarding a request 1402 along with a NO button 1404 for indicating that the information is not correct and a YES button 1406 for indicating that the information is correct.

If indication that the information is not correct is received (button 1404 is clicked), the user may be returned to a screen (e.g. screen 1200) to correct the information.

Once the information is verified and indication that it is correct is received, web server 110 forwards the information to application server 114. (4098). Application server 114 then passes the information to database 118 so that it may be recorded. (4100). If the information is not successfully recorded, database 118 may send a failure code to application server 114, which in response, may try again or send a message to web server 110 to inform the user that their was a failure and that the user should try again later. (4104).

Once the information is successfully recorded, database 118 may return a confirmation number to application server 114, which may then forward the recorded information and the confirmation number to web server 110. (2106). Web server 110 may then format the information to a user friendly display that it forwards to user terminal 102, which displays a screen informing the user of the confirmation number. (4108). This screen may be, for example, similar to screen 1100.

Referring back to stage 4059, if the user instead of selecting to create a request, selects to edit an existing redelivery request, web server 110 requests the user to enter a confirmation number. (4130). After the confirmation number is received, web server 110 sends the information to application server 114, which queries database 118 for a match between the address and confirmation number. (4132). If the confirmation number matches the address, the previously supplied information for the request associated with the confirmation number is retrieved from database 118 using application server 114. Web server 110 may then direct user terminal 102 to display a screen displaying the retrieved information. (4134). Additionally, the user may be presented with an inquiry regarding whether the user wishes to edit or cancel the request, or to simply exit and make no modifications to the request. (4136). If indication that the user elected to cancel the request or choose not to modify the request is received, the request may be cancelled by storing such an indication in database 118 or the request may be deleted from database 118. Or, the process may simply be terminated when the user elects to not modify the request. (4138). If notification that the user elected to modify the request is received, the process may proceed to stage 4086 to allow the user to request the desired modifications. Web server 110 may then direct user terminal 102 to display screens for entering information regarding the request (e.g., screens 1200 and 1300). These screens may initially display the previously provided information for the request.

After the user's request is recorded in database 118, the request becomes available to individual delivery units that log onto post office web server 119 to access data in the database. For example, as discussed above, employees from the individual delivery units may log on to database 118 via delivery unit terminals 122a through 122n. Database 118 then retrieves information for each delivery unit.

For example, delivery unit terminal 122a may provide an identifier identifying the delivery unit. Post office web server 119 may then use the identifier to retrieve information from database 118 regarding addresses handled by this delivery unit. The information regarding hold mail and redelivery requests for addresses handled by the delivery unit may then be provided by post office server 119 to delivery unit terminal 122a. This information may then be printed out onto a piece of paper using delivery unit terminal 122a and handed to an individual (e.g, the carrier) charged with delivering mail to the address. The carrier may then either hold the mail or redeliver an item as per the user's request.

Additionally, the printout provided to the individual carrier may be printed with a bar code symbol associated by database 118 with the request. The carrier may then scan this bar code symbol using a scanner assigned to the carrier so that the status of the request may be monitored. The carrier may then place the scanner in a docking station which uploads the information to database 118. Thus, database 118 may store the information regarding the status of the request. The customer may then use the confirmation number to retrieve information regarding the status of the request via web server 110.

In yet another embodiment, rather than printing out a request, delivery unit terminal 122a or any other device may automatically retrieve the information regarding requests and then e-mail these requests directly to each carrier. Carriers may then print out the request, if desired.

Also, in yet another embodiment, the screens displayed to the user may permit the user to select an alternative address for delivery of the held mail or mail to be redelivered. For example, the user may desire that a package be redelivered to their office rather than to their home. Or, a user may desire that held mail be delivered at the end of the period to an other address. In such, examples, the screens presented to the user for requesting these services may include appropriate entries for selecting and specifying alternative addresses.

Additionally, in an alternative embodiment, screens may be presented to the user for selecting a payment method for the services. For example, the user may be presented with a screen indicating the charges for the requested delivery service. This screen may also, for example, allow the user to enter a credit card number for payment, or indicate that they wished to be billed via mail.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for handling customer requests associated with special delivery services, comprising:
receiving via a network a customer request for a special delivery service;
validating the customer request;
sending the customer request to a database for recordation;
receiving an indication from the database whether the customer request was successfully recorded; and
sending the customer a confirmation number associated with the recorded customer request.

2. The method of claim 1, wherein the customer request includes a request to hold items to be delivered to the customer.

3. The method of claim 1, wherein the customer request includes a request to redeliver items to the customer.

4. The method of claim 1, wherein the customer request includes beginning and ending dates for the special delivery services.

5. The method of claim 1, wherein the customer request includes a customer address and a ZIP code.

6. The method of claim 1, wherein the customer request includes a customer additional request.

7. The method of claim 1, wherein the customer request includes a modification of the customer request already existing in the database.

8. The method of claim 5, further comprising confirming availability of requested special delivery services based on the customer ZIP code.

9. The method of claim 5, wherein validating further comprises querying the database to verify the customer address and the ZIP code.

10. The method of claim 6, wherein querying further comprises matching the customer address with one of a stored customer addresses in the database.

11. The method of claim 5, wherein validating further comprises confirming the customer address and the ZIP code.

12. The method of claim 1, further comprising printing the confirmation number associated with the recorded customer request.

13. A method for handling customer requests associated with special delivery services, comprising:
receiving via a network a customer request for a special delivery service;
validating the customer request;
recording the customer request in a database;
sending via a network an indication of whether the customer request was successfully recorded; and
sending the customer a confirmation number regarding the customer request.

14. The method of claim 13, wherein the customer request includes a request to hold items to be delivered to the customer.

15. The method of claim 13, wherein the customer request includes a request to redeliver items to the customer.

16. The method of claim 13, wherein the customer request includes beginning and ending dates for the special delivery services.

17. The method of claim 13, wherein the customer request includes a customer address and a ZIP code.

18. The method of claim 13, wherein the customer request includes a customer additional request.

19. The method of claim 13, wherein the customer request includes a modification of the customer request already existing in the database.

20. The method of claim 17, further comprising confirming availability of requested special delivery services based on the customer ZIP code.

21. The method of claim 17, wherein validating received customer request further comprises querying the database to verify the customer address and the ZIP code.

22. The method of claim 18, wherein querying the database further comprises matching the customer address with one of a stored customer addresses in the database.

23. The method of claim 17, wherein validating received customer request further comprises confirmation of the customer address and the ZIP code by the customer.

24. The method of claim 13, further comprising printing of the confirmation number associated with the recorded customer request.

25. A method for forwarding to individual carriers a customer request for special services, comprising:
retrieving via a network a customer request for a special delivery service; and
sending the customer request to a delivery unit.

26. The method of claim 25, wherein the customer request includes a request to hold items to be delivered to the customer.

27. The method of claim 25, wherein the customer request includes a request to redeliver items to the customer.

28. The method of claim 25, wherein the customer request includes beginning and ending dates for the special delivery services.

29. The method of claim 25, wherein the customer request includes a customer address and a ZIP code.

30. The method of claim 25, wherein the customer request includes a customer additional request.

31. The method of claim 25, wherein the customer request includes a modification of the customer request already existing in the database.

32. The method of claim 25, wherein retrieving further comprises printing the customer request.

33. A system for handling customer requests associated with special delivery services, comprising:
a network connection;
a server coupled to the network connection and receiving customer request associated with the special delivery services; and
a database coupled to the network connection and recording the customer request associated with the special delivery services.

34. The system of claim 33, wherein the server comprises a server sending received customer request to the database and the database comprising a database validating the customer request.
